(19) United States
(12) Patent Application Publication
(10) Pub. No.: US 2005/0039455 A1
(43) Pub. Date: Feb. 24, 2005

(54) Method for obtaining electric energy from the environment

(76) Inventor: Kurt-Uwe Borst, Kromsdorf (DE)

Correspondence Address: BIRCH STEWART KOLASCH & BIRCH, PO BOX 747, FALLS CHURCH, VA, 22040-0747, US

(21) Appl. No.: 10/486,722

(22) PCT Filed: Aug. 15, 2002
(86) PCT No.: PCT/EP02/09127

(30) Foreign Application Priority Data
Aug. 17, 2001 (DE) 10140629.0

(51) Int. Cl. F02B 1/00

(52) U.S. Cl. 60/721

(57) ABSTRACT

Up to now, conventional wind power rotors, which have a horizontal shaft and are mounted on high self-supporting poles, serve to utilize wind energy. These installations are confined to designated installation sites and, due to economical reasons, have a certain minimum size that often causes them to considerably detract from the natural scenery. The inventive method provides that the movement which is induced by changes in mechanical load, in at least one direction of displaceably mounted or elastically moving structures or parts of structures is converted into electric energy by means of mechanical/electrical energy converters situated between moving and stationary parts of structures or at selected points of elastic motion of the structures or parts of structures. This results in wind ene eing utilized over a large area.

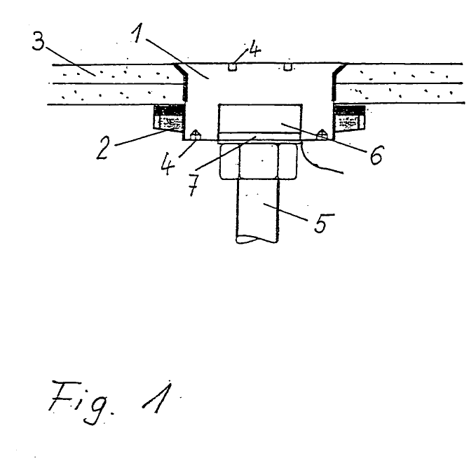

### DESCRIPTION

The utilisation of environmental energy initiated in the middle ages by mankind, wind energy in particular in those times, has been again advanced over the past decades by modem solar installations and wind power generators.

Wind power rotors mounted on horizontal shafts are almost exclusively used for utilising wind power and are located on high, free-standing masts. These generators are bound to certain locations of installation and have a certain minimum size for economic reasons. Subsequently, they frequently destroy the landscape image to a considerable degree.

Solar installations have achieved a certain technical standard after decades of development. However, they continue to require high investment costs. Calculated onto the producible energy volume during their normal life service duration, specific energy costs are incurred which make the installations only economically worthwhile with state financial support, not only with the investment costs but also with the consumption of temporary excess energy.

Moreover, the solar surface required for their operation is normally only available with detached houses and selective small scale installations.

The invention is based on the task assignment of stating and presenting a method with which environmental energy can be utilised to an economically worthwhile degree and which can be applied universally.

The task assignment is solved according to the invention by the features of the claims 1 and 14. Purposeful embodiments are included in the Sub-claims.

Accordingly, the movement caused by the mechanical load change, in at least one direction of movably supported or intrinsically elastically movable edifices or edifice parts by means of mechanical/electrical energy transducers arranged between movable and solid edifice parts or on selected points of elastic movement of the edifices or edifice parts, is transformed into electric energy.

Particularly facade parts on buildings are movably supported in any event or, if they are rigidly supported beforehand, they can be mounted on a facade in such a way that a movement probe such as a piezoelectric or electromagnetic transducer can be arranged between the support pickup at the relevant facade part and the support at the facade, where this pressure transducer generates electric energy with a wind movement of the facade part. Such facade parts include in particular window panes, windows, glass surfaces, facade slabs, e.g., attached face brick, doors etc.

A wind energy having a strong and changing intensity is permanently acting on a building surface, and this energy leads to a constant and alternating mechanical loading of the facade parts. If such facade parts are suspended in a loose and movable manner, as in the case of attached facades for example, this leads to constant movements of the facade parts. Even though these movements are not perceivable to the human eye, these movements can be used for an energy transformation. Modem pressure probes are capable of inducing a voltage even with the slightest movements. By means of a series connection and/or a parallel connection of correspondingly numerous energy transducers, usable voltage and electric energy levels can be obtained in the process. The voltage can be rectified and collected in batteries or transformed by means of converters into an energy form taken up by the network. This mode of energy production has the advantage that, in contrast with solar energy, it is available without interruption and that large surfaces with a considerable potential energy input are usable.

If a medium usable power density of approx. 10 W per square meter is adopted as a basis, a constant power of 20 kW can be generated with, for example, a free-standing office building of the usual size. This corresponds to the power that must be available for the technical building equipment or for the illumination of the building. The movement of facade parts on vertical as well as on inclined or horizontal surfaces is usable. The energy transducers can be arranged in a selective, linear or surface manner between facade part and edifice depending on the conditions prevailing locally. Normally, the energy transducers will be arranged in such a way that they make use of a movement that is running vertically to the plane of the facade parts. The energy transducers and/or corresponding supporting elements, to which the energy transducers are arranged in parallel, can be structured for this case in such a way that the movement of the facade part is taken up in one direction, but in the other directions only the forces. However, they can be structured or arranged in such a way that they are capable of taking up the movement in several directions.

If required, movement-transferring elements such as lever gears can be arranged between the facade parts and the energy transducers, where these gears increase the path or transform the movement into another form such as for example a rotary movement.

Window panes attached to a facade in a frameless condition can be held in position with point-fastenings for example, into which a mechanical/electrical energy transducer is integrated in each case. If a securement in window frames is selected for living accommodation buildings, the window panes can be embedded in the frames by means of elastic seals so that they can move against the frame to a very slight degree. Then, for example, energy transducers can be applied at the corners between frame and window pane.

The return action of the movement can be effected by means of spring elements on the support locations of the edifice parts, or the edifice parts can be arranged in such a way that, for example with a suspension in a minor inclined position, they retract by means of their own weight after a wind movement.

In addition to facade parts, further edifice facilities can also used for wind energy transformation. The movement of flags hoisted on a flagpole in the wind or the movement of the flagpole itself can be exploited where the suspension of a flag is performed in such a way that an energy transducer is arranged in between the flag and the flagpole and this transducer produces an electric voltage with the alternating movement, or where one or several elongation transducers are arranged at the flagpole which produce an electric voltage as a result of the movement of the flagpole.

In addition to wind forces, other mechanical forces occurring in the environment can be used for an energy conversion. For example the constant movement of bridges, fixed-located in so-called cup bearings, resulting from changing traffic loads can be utilised by arranging energy transducers parallel to the bearings or by integrating the transducers into these bearings.

The invention is to be described in greater detail on the basis of an embodiment example shown in one FIGURE.

The FIGURE shows a point-fastening according to the invention for large frameless glass panes. The point-fastening consists of a bush 1 which has on one side a 45°-bend and is provided with a thread to the other side, onto which a threaded ring 2 fits. Bush 1 and threaded ring 2 take up between them a glass pane 3 via a through-hole. The bush 1 is provided with face holes 4 on the front and on the rear for positioning when tightening the screws. A face hole key fits into these face holes. A bolt 5 is used for securing on an edifice. Between bush 1 and bolt 5, a piezoelectric pressure transducer is arranged which converts the smallest movements of the glass pane 3 into an electric voltage. Several such pressure transducers 6 are united in a series/parallel connection and hooked up to a converter not shown here which transfer the generated energy to the network. Between bolt 5 and the pressure transducer 6, a spring element 7, made from rubber for example, is arranged. This spring element provides for an elastic bearing-support of the glass pane.

### Referenced Parts List

1 Bush
2 Threaded ring
3 Glass pane
4 Face holes
5 Bolts
6 Pressure transducer
7 Spring element

1. Method for the production of electric energy from the environment
wherein
the movement caused by the mechanical load change, in at least one direction of movably supported or intrinsically elastically movable edifices or edifice parts by means of mechanical/electrical energy transducers arranged between movable and solid edifice parts or on selected points of elastic movement of the edifices or edifice parts, is transformed into electric energy.

2. Method according to claim 1,
wherein
the mechanical/electrical energy transducers are arranged locally and parallel to securing systems of edifice parts.

3. Method according to claim 1,
wherein
the mechanical/electrical energy transducers are arranged locally and in series to securing systems of edifice parts.

4. Method according to one of the previous claims,
wherein
facade parts are moveably joined with the edifice by way of mechanical/electrical energy transducers.

5. Method according to the claims 1 to 3,
wherein
facade parts are provided with frames which are moveably joined to the edifice by way of mechanical/electrical energy transducers.

6. Method according to claim 1,
wherein
the edifice parts are retracted into their initial position by means of spring elements following a movement caused by the wind.

7. Method according to claim 1,
wherein
the edifice parts are arranged in such a way that, after a movement caused by the wind, they retract into their initial position as a result of their own weight.

8. Method according to claim 1,
wherein
the mechanical/electrical energy transducers are integrated into point-fastenings.

9. Method according to claim 1
wherein
the mechanical/electrical energy transducers are arranged in parallel to bridge pedestal supports.

10. Method according to claim 1,
wherein
the mechanical/electrical energy transducers are integrated into bridge pedestal supports.

11. Method according to claim 1,
wherein
the mechanical/electrical energy transducers are compiled electrically in series/parallel connections.

12. Method according to claim 1,
wherein
electromagnetic transducers are used as mechanical/electrical energy transducers.

13. Method according to claim 1,
wherein
piezoelectric transducers are used as mechanical/electrical energy transducers.

14. Building,
wherein
it has facade parts which are moveably supported in at least one direction and has mechanical/electrical energy transducers arranged between the building body and the facade parts, where the electric energy of these transducers produced by the movement of the facade parts resulting from the mechanical load change is collectable in batteries or is to be fed into the network (grid).
